(19) United States
(12) Patent Application Publication
(10) Pub. No.: US 2020/0379465 A1
(43) Pub. Date: Dec. 3, 2020

(54) METHOD AND APPARATUS FOR ADUSTING SENSOR FIELD OF VIEW

(71) Applicant: GM GLOBAL TECHNOLOGY OPERATIONS LLC, DETROIT, MI (US)

(72) Inventors: Paul A. Adam, MILFORD, MI (US); Namal P. Kumara, Ypsilanti, MI (US); Gabriel T. Choi, Novi, MI (US); Donovan J. Wisner, Ann Arbor, MI (US)

(21) Appl. No.: 16/427,919

(22) Filed: May 31, 2019

(51) Int. Cl. G05D 1/02

(52) U.S. Cl. CPC G05D 1/024; G01S 17/936; G05D 2201/0213; G05D 1/0246

(57) ABSTRACT

A method and apparatus that adjust a field of view of a sensor are provided. The method includes detecting at least one target object in an effective field of view of the sensor, determining an area corresponding to the effective field of view of the sensor, determining whether a critical zone is within the effective field of view based on the determined area of the effective field of view, parameters corresponding to the at least one target object, and parameters corresponding to the host vehicle, and moving the host vehicle within its lane of travel to adjust the effective field of view to capture the critical zone in response to determining that the critical zone is not within the effective field of view.

### INTRODUCTION

Apparatuses and methods consistent with exemplary embodiments relate to sensors on vehicles. More particularly, apparatuses and methods consistent with exemplary embodiments relate to the field of view of sensors on the vehicles.

### SUMMARY

One or more exemplary embodiments provide a method and an apparatus that adjust a field of view of a sensor on a vehicle. More particularly, one or more exemplary embodiments provide a method and an apparatus that move a vehicle to adjust the field of view of a sensor on a vehicle to capture a critical zone in an area of interest such as an adjacent lane.

According to an aspect of exemplary embodiment, a method that adjusts a field of view of a sensor on a vehicle is provided. The method includes detecting at least one target object in an effective field of view of the sensor, determining an area corresponding to the effective field of view of the sensor, determining whether a critical zone is within the effective field of view based on the determined area of the effective field of view, parameters corresponding to the at least one target object, and parameters corresponding to the host vehicle, and moving the host vehicle within its lane of travel to adjust the effective field of view to capture the critical zone in response to determining that the critical zone is not within the effective field of view.

The method may further include performing a lane change with the host vehicle if the critical zone is within the current field of view.

The critical zone may include an area adjacent to a host vehicle in one or more lanes next to the host vehicle.

The parameters corresponding to the at least one target object may include one or more from among a speed of the target object, a size of the target object, a number of target objects, an acceleration of the target object, and a position of the target object.

The parameters corresponding to the host vehicle may include one or more from among a speed of the host vehicle, a size of the host vehicle, an acceleration of the host vehicle, a position of the host vehicle, and a heading of the host vehicle relative to the target object or a lane of travel of the host vehicle.

An area of the critical zone may be determined based on dimensions of the host vehicle and dimensions of the target object.

The moving the host vehicle within its lane of travel may include adjusting the host vehicle trajectory of the host vehicle heading so that host vehicle travels closer to an edge of the lane adjacent to the critical zone.

The sensor may include one from among a camera, a lidar sensor, a radar sensor, and an ultrasonic sensor.

The critical zone may be defined by coordinates relative to the host vehicle, the coordinates expressing boundaries of a polygon defining an area where the detected at least one target object would pose a threat to the host vehicle. a function of one or more from among

According to an aspect of an exemplary embodiment, an apparatus that adjusts a field of view of a sensor on a vehicle is provided. The apparatus includes at least one memory including computer executable instructions and at least one processor configured to read and execute the computer executable instructions. The computer executable instructions causing the at least one processor to detect at least one target object in an effective field of view of the sensor, determine an area corresponding to the effective field of view of the sensor, determine whether a critical zone is within the effective field of view based on the determined area of the effective field of view, parameters corresponding to the at least one target object, and parameters corresponding to the host vehicle; and move the host vehicle within its lane of travel to adjust the effective field of view to capture the critical zone in response to determining that the critical zone is not within the effective field of view.

The computer executable instructions may further cause the at least one processor to perform a lane change with the host vehicle if the critical zone is within the current field of view.

The critical zone may include an area adjacent to a host vehicle in one or more lanes next to the host vehicle.

The parameters corresponding to the at least one target object may include one or more from among a speed of the target object, a size of the target object, a number of target objects, an acceleration of the target object, a position of the target object.

The parameters corresponding to the host vehicle may include one or more from among a speed of the host vehicle, a size of the host vehicle, an acceleration of the host vehicle, a position of the host vehicle and a heading of the host vehicle relative to the target object or a lane of travel of the host vehicle.

The computer executable instructions may cause the at least one processor to determine an area of the critical zone based on dimensions of the host vehicle and dimensions of the target object.

The computer executable instructions may cause the at least one processor to move the host vehicle within its lane of travel by adjusting the host vehicle trajectory of the host vehicle heading so that host vehicle travels closer to an edge of the lane adjacent to the critical zone.

The apparatus may include the sensor, the sensor being one from among a camera, a lidar sensor, a radar sensor, and an ultrasonic sensor.

The critical zone may be defined by coordinates relative to the host vehicle, the coordinates expressing boundaries of a polygon defining an area where the detected at least one target object would pose a threat to the host vehicle.

The computer executable instructions may further cause the at least one processor to set the coordinates based on one or more from among a size of the host vehicle, a velocity of the host vehicle, an average velocity of travel in a lane that is part of the critical zone, and a desired gap between the host vehicle and target objects.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that adjusts a field of view of a sensor according to an exemplary embodiment;

FIG. 2 shows a flowchart for a method that adjusts a field of view of a sensor according to an exemplary embodiment; and

FIGS. 3A and 3B show illustrations of adjusting a field of view of a sensor according to an aspect of an exemplary embodiment.

### DETAILED DESCRIPTION OF EXEMPLARY EMBODIMENTS

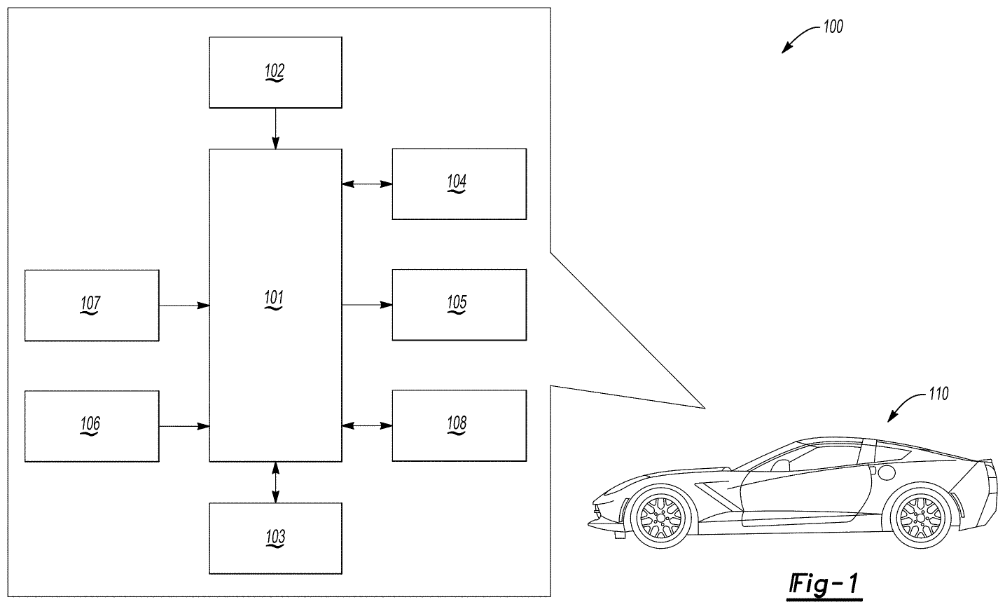

An apparatus and method that adjust a field of view of a sensor will now be described in detail with reference to FIGS. 1-3 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles are being equipped with sensors that are capable of providing information to determine a position of a host vehicle, a target object and to detect conditions of an environment around a vehicle. The sensors provide information on conditions or features of a location of a vehicle and this information may be used to control the vehicle or to assist an operator of the vehicle. In one example, sensors may sense lanes or areas adjacent to a host vehicle to detect objects and provide information that may be used to maneuver a vehicle or perform a lane change.

Depending on the position of the host vehicle, the sensor may have an effective field of view that is limited or less than its full field of view. The effective field of view may be limited by obstructions caused by objects in the field of view of sensor, objects attached to the host vehicle, a location of the host vehicle relative to the required area corresponding to complete field of view, or other debris interfering or blocking the full field of view of the sensor. One way to address the issue of a limited field of view of one sensor is to add additional sensors to cover a larger field of view or to create overlapping fields of view in order to use the field of view from a second sensor to address a situation when the effective field of view of a first sensor is limited. Another way to address the issue of a limited field of view is to move the sensor itself to capture a larger effective field of view. However, both of these solutions require additional costs due to increased components and complexity.

An alternative solution that utilizes the vehicle and a stationary or fixed sensor would be to detect when the effective field of view of a sensor does not include a critical zone or a zone that a sensor must sense and provide information to the vehicle for the vehicle to perform a maneuver. In this scenario, it may be possible to control the vehicle by changing its trajectory, its heading, or its offset from a lane marker. The changes will allow the vehicle to travel closer to the edge of an adjacent lane and increase the size of the effective field of view of the sensor to completely capture the critical zone.

FIG. 1 shows a block diagram of an apparatus that adjusts a field of view of a sensor 100. As shown in FIG. 1, the apparatus that adjusts a field of view of a sensor 100, according to an exemplary embodiment, includes a controller 101, a power supply 102, a storage 103, an output 104, vehicle controls 105, a user input 106, a sensor 107, and a communication device 108. However, the apparatus that adjusts a field of view of a sensor 100 is not limited to the aforementioned configuration and may be configured to include additional elements and/or omit one or more of the aforementioned elements. The apparatus that adjusts a field of view of a sensor 100 may be implemented as part of a vehicle 110, as a standalone component, as a hybrid between an on vehicle and off vehicle device, or in another computing device.

The controller 101 controls the overall operation and function of the apparatus that adjusts a field of view of a sensor 100. The controller 101 may control one or more of a storage 103, an output 104, vehicle controls 105, a user input 106, a sensor 107, and a communication device 108 of the apparatus that adjusts a field of view of a sensor 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the vehicle controls 105, the user input 106, the sensor 107, and the communication device 108 of the apparatus that adjusts a field of view of a sensor 100. The information may be sent and received via a bus or network, or may be directly read or written to/from one or more of the storage 103, the output 104, the user input 106, the sensor 107, and the communication device 108 of the apparatus that adjusts a field of view of a sensor 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the vehicle controls 105, the user input 106, the sensor 107, and the communication device 108, of the apparatus that adjusts a field of view of a sensor 100. The power supply 102 may include one or more from among a battery, an outlet, a capacitor, a solar energy cell, a generator, a wind energy device, an alternator, etc.

The storage 103 is configured for storing information and retrieving information used by the apparatus that adjusts a field of view of a sensor 100. The storage 103 may be controlled by the controller 101 to store and retrieve information received from the controller 101, the vehicle controls 105, the sensor 107, and/or the communication device 108. The information may include parameters corresponding to the at least one target object, parameters corresponding to the host vehicle, information on the critical zone, and information on the effective field of view. The storage 103 may also store the computer instructions configured to be executed by a processor to perform the functions of the apparatus that adjusts a field of view of a sensor 100.

The parameters corresponding to the host vehicle may include one or more from among a speed of the host vehicle, a size of the host vehicle, an acceleration of the host vehicle, a position of the host vehicle, and a heading of the host vehicle relative to a current lane of travel or target objects. The parameters corresponding to the at least one target object may include one or more from among a speed of the target object, a size of the target object, a number of target objects, an acceleration of the target object, and a position of the target object. The critical zone information may include one or more of coordinates of the critical zone and a size of the critical zone. The information on the effective field of view may include one or more from among coordinates of the perimeter of the effective field of view, dimensions of the effective field of view, and a size of the effective may be determined based on data provided by sensor, a position of the host vehicle, and positions of target objects.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that adjusts a field of view of a sensor 100. The output 104 may include one or more from among a speaker, an audio device, a display, a centrally-located display, a head up display, a windshield display, a haptic feedback device, a vibration device, a tactile feedback device, a tap-feedback device, a holographic display, an instrument light, an indicator light, etc.

The output 104 may output a notification including one or more from among an audible notification, a light notification, and a display notification. The notifications may indicate information on whether it is safe to execute a vehicle maneuver, for example a lane change maneuver.

The vehicle controls 105 may include vehicle system modules (VSMs) in the form of electronic hardware components that are located throughout the vehicle and typically receive input from one or more sensors and use the sensed input to perform diagnostic monitoring, control the vehicle to perform maneuvers, accelerate, brake, decelerate, report and/or other functions. Each of the VSMs may be connected by a communications bus to the other VSMs, as well as to the controller 101, and can be programmed to run vehicle system and subsystem diagnostic tests. The controller 101 may be configured to send and receive information from the VSMs and to control VSMs to perform vehicle functions.

As examples, one VSM can be an engine control module (ECM) that controls various aspects of engine operation such as fuel ignition and ignition timing, another VSM can be an external sensor module configured to receive information from external sensors such as cameras, radars, LIDARs, and lasers, another VSM can be a powertrain control module that regulates operation of one or more components of the vehicle powertrain, another VSM can be the vehicle dynamics sensor that detects a steering wheel angle parameter, a speed parameter, an acceleration parameter, a lateral acceleration parameter, and/or a road wheel angle parameter, and another VSM can be a body control module that governs various electrical components located throughout the vehicle, like the vehicle's power door locks and headlights. As is appreciated by those skilled in the art, the above-mentioned VSMs are only examples of some of the modules that may be used in a vehicle, as numerous others are also available.

The user input 106 is configured to provide information and commands to the apparatus that adjusts a field of view of a sensor 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a steering wheel, a touchpad, etc. The user input 106 may be configured to receive a user input to acknowledge or dismiss the notification output by the output 104.

The sensor 107 may include one or more from among a plurality of sensors including a camera, a laser sensor, an ultrasonic sensor, an infrared camera, a LIDAR, a radar sensor, an ultra-short range radar sensor, an ultra-wideband radar sensor, and a microwave sensor. The sensor 107 may be configured to scan an area around a vehicle to detect and provide imaging information including an image of the area around the vehicle. The sensor 107 may be used to compile imaging information, high resolution mapping information or data including three-dimensional point cloud information.

The communication device 108 may be used by the apparatus that adjusts a field of view of a sensor 100 to communicate with various types of external apparatuses according to various communication methods. The communication device 108 may be used to send/receive information including the information on a location of a vehicle, global navigation information, and/or image sensor information.

The communication device 108 may include various communication modules such as one or more from among a telematics unit, a broadcast receiving module, a near field communication (NFC) module, a GNS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GNS receiver is a module that receives a GNS signal from a GPS satellite or other navigation satellite or tower and that detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an exemplary embodiment, the controller 101 of the apparatus that adjusts a field of view of a sensor 100 may be configured to detect at least one target object in an effective field of view of the sensor, determine an area corresponding to the effective field of view of the sensor, determine whether a critical zone is within the effective field of view based on the determined area of the effective field of view, parameters corresponding to the at least one target object, and parameters corresponding to the host vehicle, and move the host vehicle within its lane of travel to adjust the effective field of view to capture the critical zone in response to determining that the critical zone is not within the effective field of view.

The controller 101 of the apparatus that adjusts a field of view of a sensor 100 may be further configured to perform a lane change with the host vehicle if the critical zone is within the current field of view.

The controller 101 of the apparatus that adjusts a field of view of a sensor 100 may be further configured to move the host vehicle within its lane of travel by adjusting the host vehicle trajectory of the host vehicle heading so that host vehicle travels closer to an edge of the lane adjacent to the critical zone.

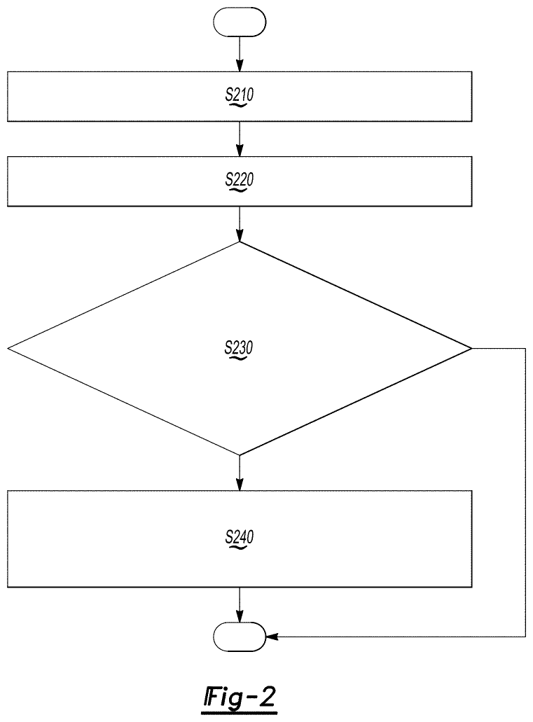

FIG. 2 shows a flowchart for a method that adjusts a field of view of a sensor according to an exemplary embodiment. The method of FIG. 2 may be performed by the apparatus that adjusts a field of view of a sensor 100 or may be encoded into a computer readable medium as instructions that are executable by a computer to perform the method.

Referring to FIG. 2, a target objected in the effective field of view of the sensor is detected in operation S210. Detecting the target object may be performed via information provided by the sensor or information from another sensor. Moreover, operation S210 may be optional as the effective field of view may be adjusted without detecting a target object in the effective field of view of the sensor.

In operation S220, the area corresponding to the effective field of view of the sensor is determined or calculated. For example, one or more from among coordinates of the perimeter of the effective field of view, dimensions of the effective field of view, and a size of the effective may be determined based on data provided by the sensor, a position of the host vehicle, and positions of target objects.

In operation S230, it is determined whether a critical zone is within the effective field of view based on the determined area of the effective field of view, parameters corresponding to a target object, and parameters corresponding to a host vehicle. Then, in operation S240, the host vehicle is moved within the lane of travel to adjust the effective field of view and capture the critical zone in response to determining that the critical zone is not within the effective field of view (Operation S230—No). Otherwise, the process ends (Operation S230—Yes).

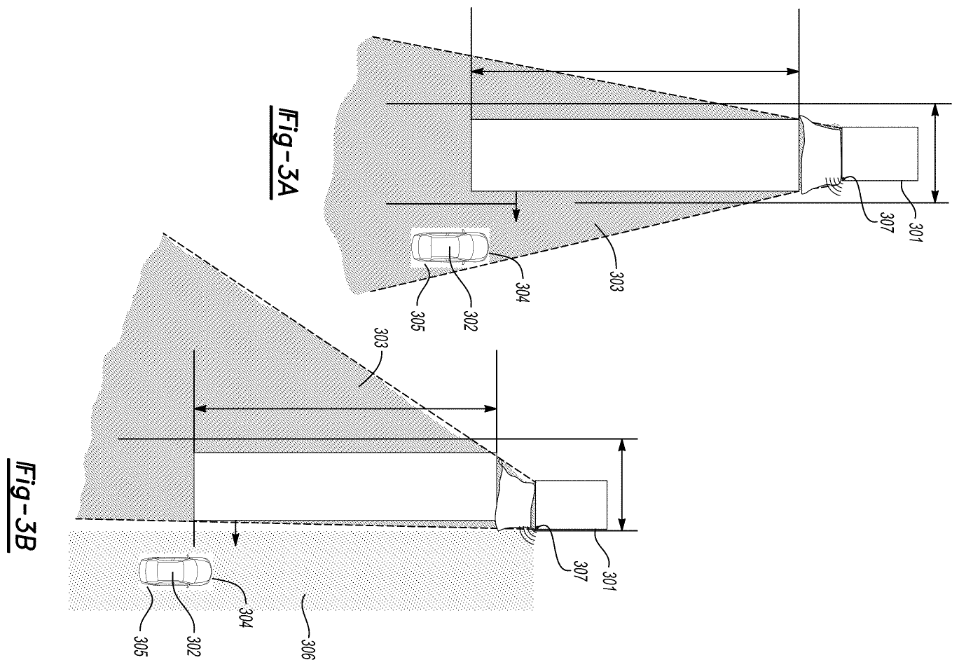

FIGS. 3A and 3B show illustrations of adjusting a field of view of a sensor according to an aspect of an exemplary embodiment.

Referring to FIG. 3A, a host vehicle 301 is traveling in a center lane. The host vehicle in this example may be a truck towing a trailer. The host vehicle 301 may include one or more sensors 307. The sensors may not detect or may only partially detect a target object or target vehicle 302 due to the fact the effective field of view 305 of sensor 307 does not include critical zone 303 in the adjacent lane 304.

Referring to FIG. 3B, the host vehicle 301 moves within the center lane or its lane of travel, thereby capturing the entire critical zone 306 and detecting the target vehicle 302. By performing this maneuver, the host vehicle 301 will be able to determine whether it is safe to perform a lane change into the adjacent lane 304.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for adjusting a field of view of a sensor, the method comprising:
detecting at least one target object in an effective field of view of the sensor;
determining an area corresponding to the effective field of view of the sensor;
determining whether a critical zone is within the effective field of view based on the determined area of the effective field of view, parameters corresponding to the at least one target object, and parameters corresponding to the host vehicle; and
moving the host vehicle within its lane of travel to adjust the effective field of view to capture the critical zone in response to determining that the critical zone is not within the effective field of view.

2. The method of claim 1, further comprising performing a lane change with the host vehicle if the critical zone is within the current field of view.

3. The method of claim 1, wherein the critical zone comprises an area adjacent to a host vehicle in one or more lanes next to the host vehicle.

4. The method of claim 1, wherein the parameters corresponding to the at least one target object comprise one or more from among a speed of the target object, a size of the target object, a number of target objects, an acceleration of the target object, and a position of the target object.

5. The method of claim 1, wherein the parameters corresponding to the host vehicle comprise one or more from among a speed of the host vehicle, a size of the host vehicle, an acceleration of the host vehicle, a position of the host vehicle, and a heading of the host vehicle relative to the target object or a lane of travel of the host vehicle.

6. The method of claim 1, wherein an area of the critical zone is determined based on dimensions of the host vehicle and dimensions of the target object.

7. The method of claim 1, wherein the moving the host vehicle within its lane of travel comprises adjusting the host vehicle trajectory of the host vehicle heading so that host vehicle travels closer to an edge of the lane adjacent to the critical zone.

8. The method of claim 1, wherein the sensor comprises one from among a camera, a lidar sensor, a radar sensor, and an ultrasonic sensor.

9. The method of claim 1, wherein the critical zone is defined by coordinates relative to the host vehicle, the coordinates expressing boundaries of a polygon defining an area where the detected at least one target object would pose a threat to the host vehicle. a function of one or more from among

10. A non-transitory computer readable medium comprising computer instructions executable to perform the method of claim 1.

11. An apparatus that for adjusts a field of view of a sensor, the apparatus comprising:
at least one memory comprising computer executable instructions; and
at least one processor configured to read and execute the computer executable instructions, the computer executable instructions causing the at least one processor to:
detect at least one target object in an effective field of view of the sensor;
determine an area corresponding to the effective field of view of the sensor;
determine whether a critical zone is within the effective field of view based on the determined area of the effective field of view, parameters corresponding to the at least one target object, and parameters corresponding to the host vehicle; and
move the host vehicle within its lane of travel to adjust the effective field of view to capture the critical zone in response to determining that the critical zone is not within the effective field of view.

12. The apparatus of claim 11, wherein the computer executable instructions further cause the at least one processor to perform a lane change with the host vehicle if the critical zone is within the current field of view.

13. The apparatus of claim 11, wherein the critical zone comprises an area adjacent to a host vehicle in one or more lanes next to the host vehicle.

14. The apparatus of claim 11, wherein the parameters corresponding to the at least one target object comprise one or more from among a speed of the target object, a size of the target object, a number of target objects, an acceleration of the target object, a position of the target object.

15. The apparatus of claim 11, wherein the parameters corresponding to the host vehicle comprise one or more from among a speed of the host vehicle, a size of the host vehicle, an acceleration of the host vehicle, a position of the host vehicle and a heading of the host vehicle relative to the target object or a lane of travel of the host vehicle.

16. The apparatus of claim 11, wherein an area of the critical zone is determined based on dimensions of the host vehicle and dimensions of the target object.

17. The apparatus of claim 11, wherein the computer executable instructions cause the at least one processor to move the host vehicle within its lane of travel by adjusting the host vehicle trajectory of the host vehicle heading so that host vehicle travels closer to an edge of the lane adjacent to the critical zone.

18. The apparatus of claim 11, further comprising the sensor, wherein the sensor one from among a camera, a lidar sensor, a radar sensor, and an ultrasonic sensor.

19. The apparatus of claim 11, wherein the critical zone is defined by coordinates relative to the host vehicle, the coordinates expressing boundaries of a polygon defining an area where the detected at least one target object would pose a threat to the host vehicle.

20. The apparatus of claim 11, wherein the computer executable instructions cause the at least one processor to set the coordinates based on one or more from among a size of the host vehicle, a velocity of the host vehicle, an average velocity of travel in a lane that is part of the critical zone, and a desired gap between the host vehicle and target objects.
